(19) United States
(12) Patent Application Publication
(10) Pub. No.: US 2023/0289690 A1
(43) Pub. Date: Sep. 14, 2023

(54) Fallout Management Engine (FAME)

(71) Applicant: CenturyLink Intellectual Property LLC, Broomfield, CO (US)

(72) Inventors: Santhosh Plakkatt, Bangalore (IN); Lakshmi Narayana Bojanapu, Bangalore (IN)

(21) Appl. No.: 17/842,617

(22) Filed: Jun. 16, 2022

Related U.S. Application Data
(60) Provisional application No. 63/319,414, filed on Mar. 14, 2022.

(51) Int. Cl. G06Q 10/06

(52) U.S. Cl. CPC G06Q 10/0633

(57) ABSTRACT

Novel tools and techniques are provided for implementing fallout identification, management, and resolution using a fallout management engine (“FAME”). In various embodiments, a computing system may analyze a first set of data to identify characteristics of fallout, based on a learning model, wherein fallout may comprise at least one of blockage, break, and/or disruption in a service order workflow of an ordering and provisioning system. The computing system may analyze the identified characteristics of fallout with respect to the at least one of service order workflow, business logic, and/or business rules, to perform one or more tasks including identifying patterns or signatures of a fallout event, identifying root causes of the fallout event, and/or generating a dynamic prioritization map for resolving the fallout event, and/or the like. The computing system may generate and send one or more recommendations regarding the identified fallout event based on the one or more tasks.

### CROSS-REFERENCES TO RELATED APPLICATIONS

This application claims priority to U.S. Patent Application Ser. No. 63/319,414 (the “'414 Application”), filed Mar. 14, 2022, by Santhosh Plakkatt et al. (attorney docket no. 1706-US-P1), entitled, “Fallout Management Engine (FAME),” the disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing fallout identification, management, and resolution, and, more particularly, to methods, systems, and apparatuses for implementing fallout identification, management, and resolution using a fallout management engine (“FAME”).

### BACKGROUND

In conventional ordering and/or provisioning systems, order workflow can come to a stop due to a variety of application reasons, technical reasons, and/or interface reasons, causing direct revenue losses and customer impact. Conventional fallout detection and resolution techniques rely on static point of failure detection, and are also otherwise limited in scope of identification, management, and resolution.

Hence, there is a need for more robust and scalable solutions for implementing fallout identification, management, and resolution.

### SUMMARY

The techniques of this disclosure generally relate to tools and techniques for implementing fallout identification, management, and resolution, and, more particularly, to methods, systems, and apparatuses for implementing fallout identification, management, and resolution using a fallout management engine (“FAME”).

In an aspect, a method may comprise receiving, using a computing system, a first set of data associated with a service order workflow through an ordering and provisioning system, the service order workflow corresponding to ordering and provisioning of a service or a product that is provided or sold by a service provider; analyzing, using the computing system, the first set of data to identify characteristics of fallout with respect to at least one of the service order workflow, business logic, or business rules, and/or the like, that are associated with the ordering and provisioning of the service or the product using the ordering and provisioning system, based on a learning model, wherein fallout may comprise at least one of a blockage, a break, or a disruption in the service order workflow with respect to at least one of one or more software components or one or more hardware components of the ordering and provisioning system; analyzing, using a resolution engine of the computing system, the identified characteristics of fallout with respect to the at least one of the service order workflow, the business logic, or the business rules, and/or the like, to perform at least one of identifying one or more patterns or signatures of an identified fallout event, identifying one or more root causes of the identified fallout event, or generating a dynamic prioritization map for resolving the identified fallout event, and/or the like; and generating and sending, using the computing system, one or more recommendations regarding the identified fallout event based on at least one of the identified patterns or signatures of the identified fallout event, the identified one or more root causes of the identified fallout event, or the generated dynamic prioritization map for resolving the identified fallout event, and/or the like.

In some embodiments, the computing system may comprise at least one of a fallout management engine (“FAME”), an artificial intelligence (“AI”) system, a machine learning system, a deep learning system, a server computer over a network, a cloud computing system, or a distributed computing system, and/or the like. In some cases, the first set of data may comprise at least one of event data, real-time event data, logged event data, simulated event data, point of failure (“POF”) data, static POF data, dynamic POF data, actual POF data, simulated POF data, information technology service management (“ITSM”) data, workflow event data, ordering and provisioning system workflow event data, business workflow event data, service workflow event data, order workflow event data, service order management input data, product order management input data, service order incident data, product order incident data, warning data, event log data, error data, alert data, human resources input data, service team input data, or sales team input data, and/or the like.

According to some embodiments, analyzing the first set of data to identify the characteristics of fallout with respect to the at least one of the service order workflow, the business logic, or the business rules, and/or the like, may comprise: performing, using the computing system, data classification on the first set of data, by providing data labelling to the first set of data based at least in part on type of data; performing, using the computing system, data cleaning on the first set of data based at least in part on the data classification to produce a second set of data, the second set of data comprising at least one of data associated with the service order workflow, data associated with a fallout event, or event data, and/or the like, without private data associated with a customer and without customer proprietary data, or the like; performing, using the computing system, data aggregation on the second set of data to produce aggregated data for each of the at least one of the data associated with the service order workflow, the data associated with the fallout event, or the event data, and/or the like, based at least in part on data labelling and data classification; performing, using the computing system, feature extraction on the aggregated data to identify at least one of key features or attributes of data associated with the service order workflow from among the aggregated data; analyzing, using a business logic manager of the computing system, the identified at least one of key features or attributes of the data associated with the service order workflow from among the aggregated data to identify at least one of one or more business logic or one or more business rules that either are impacted by the identified fallout event or are contributing to occurrence of the identified fallout event; and identifying, using the learning model, the characteristics of fallout with respect to the at least one of the service order workflow, the business logic, or the business rules, and/or the like, based at least in part on the identified at least one of key features or attributes of the data associated with the service order workflow from among the aggregated data and the identified at least one of one or more business logic or one or more business rules that either are impacted by the identified fallout event or are contributing to occurrence of the identified fallout event.

In some instances, the learning model may be an artificial intelligence (“AI”) model, wherein the method may further comprise updating, using the computing system, the learning model to improve identification of the characteristics of fallout with respect to the at least one of the service order workflow, the business logic, or the business rules, and/or the like, based at least in part on any changes to the characteristics of fallout with respect to the at least one of the service order workflow, the business logic, or the business rules, and/or the like, due to one or more of the identified at least one of key features or attributes of the data associated with the service order workflow from among the aggregated data or the identified at least one of one or more business logic or one or more business rules that either are impacted by the identified fallout event or are contributing to occurrence of the identified fallout event, and/or the like.

In some embodiments, the first set of data may comprise at least one of end-to-end (“E2E”) data associated with the entire service order workflow across an application layer of the ordering and provisioning system or E2E data associated with the entire service order workflow across a network layer of the ordering and provisioning system, and/or the like, wherein analyzing the first set of data to identify the characteristics of fallout with respect to the at least one of the service order workflow, the business logic, or the business rules, and/or the like, may comprise analyzing, using the computing system, the first set of data to identify characteristics of fallout across the entire service order workflow across at least one of the application layer or the network layer, and/or the like, with respect to at least one of the service order workflow, business logic, or business rules, and/or the like, that are associated with the ordering and provisioning of the service or the product using the ordering and provisioning system, based on the learning model. In some cases, the E2E data associated with the entire service order workflow across the application layer of the ordering and provisioning system may comprise E2E data associated with the entire application layer, wherein the E2E data associated with the entire service order workflow across the network layer of the ordering and provisioning system may comprise E2E data associated with the entire network layer, wherein the one or more software components may be associated with the application layer, and wherein the one or more hardware components may be associated with the network layer.

According to some embodiments, performing the at least one of identifying the one or more patterns or signatures of the identified fallout event, identifying the one or more root causes of the identified fallout event, or generating the dynamic prioritization map for resolving the identified fallout event, and/or the like, may occur in real-time or near-real-time, wherein the identified patterns or signatures may be real-time or near-real-time patterns or signatures of the identified fallout event, the identified one or more root causes may be real-time or near-real-time root causes of the identified fallout event, or the generated dynamic prioritization map may be a real-time or near-real-time dynamic prioritization map for resolving the identified fallout event.

In some embodiments, the method may further comprise generating, using the computing system, dynamic point of failure (“POF”) data that simulates POF data corresponding to one or more potential fallout events occurring in the service order workflow across at least one of an application layer of the ordering and provisioning system or a network layer of the ordering and provisioning system; and feeding, using the computing system, the generated dynamic POF data through a feedback loop, and repeating the processes of receiving the first set of data, analyzing the first set of data, analyzing the identified characteristics of fallout, and generating and sending the one or more recommendations, to anticipate, and to recommend fixes for, potential fallout events before they occur, wherein the first set of data may comprise the generated dynamic POF data. In some instances, the processes of generating the dynamic POF data, feeding the generated dynamic POF data through the feedback loop, receiving the first set of data, analyzing the first set of data, analyzing the identified characteristics of fallout, and generating and sending the one or more recommendations may be repeated one or more times with different dynamic POF data being generated and used as the first set of data for each repetition, to anticipate, and to recommend fixes for, additional potential fallout events before they occur.

According to some embodiments, the method may further comprise determining, using the computing system, a tolerance level for a class of service or product associated with the service or product that is provided or sold by the service provider; determining, using the computing system, a confidence level corresponding to at least one of a level of confidence that the identified patterns or signatures correspond to actual patterns or signatures of the identified fallout event, a level of confidence that the identified one or more root causes correspond to actual root causes of the identified fallout event, or a level of confidence that the generated dynamic prioritization map corresponds to a viable dynamic prioritization map for resolving the identified fallout event, and/or the like; and based on a determination that the determined confidence level exceeds the determined tolerance level for the class of service or product associated with the service or product that is provided or sold by the service provider, generating, using the computing system, one or more automated repair protocols, and implementing, using the computing system, the one or more automated repair protocols, wherein the one or more automated repair protocols may comprise at least one of one or more new business logic, one or more new business rules, a new service order workflow, one or more automated fixes to one or more existing business logic, one or more automated fixes to one or more existing business rules, or one or more automated fixes to the service order workflow, and/or the like.

In another aspect, a system may comprise a computing system, which may comprise a resolution engine, at least one first processor, and a first non-transitory computer readable medium communicatively coupled to the at least one first processor. The first non-transitory computer readable medium may have stored thereon computer software comprising a first set of instructions that, when executed by the at least one first processor, causes the computing system to: receive a first set of data associated with a service order workflow through an ordering and provisioning system, the service order workflow corresponding to ordering and provisioning of a service or a product that is provided or sold by a service provider; analyze the first set of data to identify characteristics of fallout with respect to at least one of the service order workflow, business logic, or business rules, and/or the like, that are associated with the ordering and provisioning of the service or the product using the ordering and provisioning system, based on a learning model, wherein fallout may comprise at least one of a blockage, a break, or a disruption in the service order workflow with respect to at least one of one or more software components or one or more hardware components of the ordering and provisioning system; analyze, using the resolution engine, the identified characteristics of fallout with respect to the at least one of the service order workflow, the business logic, or the business rules, and/or the like, to perform at least one of identifying one or more patterns or signatures of an identified fallout event, identifying one or more root causes of the identified fallout event, or generating a dynamic prioritization map for resolving the identified fallout event, and/or the like; and generate and send one or more recommendations regarding the identified fallout event based on at least one of the identified patterns or signatures of the identified fallout event, the identified one or more root causes of the identified fallout event, or the generated dynamic prioritization map for resolving the identified fallout event, and/or the like.

In some embodiments, the computing system may comprise at least one of a fallout management engine (“FAME”), an artificial intelligence (“AI”) system, a machine learning system, a deep learning system, a server computer over a network, a cloud computing system, or a distributed computing system, and/or the like. In some instances, the first set of data may comprise at least one of event data, real-time event data, logged event data, simulated event data, point of failure (“POF”) data, static POF data, dynamic POF data, actual POF data, simulated POF data, information technology service management (“ITSM”) data, workflow event data, ordering and provisioning system workflow event data, business workflow event data, service workflow event data, order workflow event data, service order management input data, product order management input data, service order incident data, product order incident data, warning data, event log data, error data, alert data, human resources input data, service team input data, or sales team input data, and/or the like.

According to some embodiments, the first set of data may comprise at least one of end-to-end (“E2E”) data associated with the entire service order workflow across an application layer of the ordering and provisioning system or E2E data associated with the entire service order workflow across a network layer of the ordering and provisioning system, wherein analyzing the first set of data to identify the characteristics of fallout with respect to the at least one of the service order workflow, the business logic, or the business rules, and/or the like, may comprise analyzing, using the computing system, the first set of data to identify characteristics of fallout across the entire service order workflow across at least one of the application layer or the network layer, with respect to at least one of the service order workflow, business logic, or business rules, and/or the like, that are associated with the ordering and provisioning of the service or the product using the ordering and provisioning system, based on the learning model.

In some embodiments, performing the at least one of identifying the one or more patterns or signatures of the identified fallout event, identifying the one or more root causes of the identified fallout event, or generating the dynamic prioritization map for resolving the identified fallout event may occur in real-time or near-real-time, wherein the identified patterns or signatures may be real-time or near-real-time patterns or signatures of the identified fallout event, the identified one or more root causes may be real-time or near-real-time root causes of the identified fallout event, or the generated dynamic prioritization map may be a real-time or near-real-time dynamic prioritization map for resolving the identified fallout event.

According to some embodiments, the first set of instructions, when executed by the at least one first processor, may further cause the computing system to: generate dynamic point of failure (“POF”) data that simulates POF data corresponding to one or more potential fallout events occurring in the service order workflow across at least one of an application layer of the ordering and provisioning system or a network layer of the ordering and provisioning system; and feed the generated dynamic POF data through a feedback loop, and repeat the processes of receiving the first set of data, analyzing the first set of data, analyzing the identified characteristics of fallout, and generating and sending the one or more recommendations, to anticipate, and to recommend fixes for, potential fallout events before they occur, wherein the first set of data may comprise the generated dynamic POF data. In some instances, the processes of generating the dynamic POF data, feeding the generated dynamic POF data through the feedback loop, receiving the first set of data, analyzing the first set of data, analyzing the identified characteristics of fallout, and generating and sending the one or more recommendations may be repeated one or more times with different dynamic POF data being generated and used as the first set of data for each repetition, to anticipate, and to recommend fixes for, additional potential fallout events before they occur.

In some embodiments, the first set of instructions, when executed by the at least one first processor, may further cause the computing system to: determine a tolerance level for a class of service or product associated with the service or product that is provided or sold by the service provider; determine a confidence level corresponding to at least one of a level of confidence that the identified patterns or signatures correspond to actual patterns or signatures of the identified fallout event, a level of confidence that the identified one or more root causes correspond to actual root causes of the identified fallout event, or a level of confidence that the generated dynamic prioritization map corresponds to a viable dynamic prioritization map for resolving the identified fallout event, and/or the like; based on a determination that the determined confidence level exceeds the determined tolerance level for the class of service or product associated with the service or product that is provided or sold by the service provider, generate one or more automated repair protocols, and implement the one or more automated repair protocols, wherein the one or more automated repair protocols comprise at least one of one or more new business logic, one or more new business rules, a new service order workflow, one or more automated fixes to one or more existing business logic, one or more automated fixes to one or more existing business rules, or one or more automated fixes to the service order workflow, and/or the like.

In yet another aspect, a method may comprise receiving, using a computing system, dynamic point of failure (“POF”) data that simulates POF data corresponding to one or more potential fallout events occurring in a service order workflow through an ordering and provisioning system, the service order workflow corresponding to ordering and provisioning of a service or a product that is provided or sold by a service provider; analyzing, using the computing system, the dynamic POF data to identify characteristics of potential fallout with respect to at least one of the service order workflow, business logic, or business rules, and/or the like, that are associated with the ordering and provisioning of the service or the product using the ordering and provisioning system, based on a learning model, wherein the potential fallout may comprise at least one of a potential blockage, a potential break, or a potential disruption in the service order workflow with respect to at least one of one or more software components or one or more hardware components of the ordering and provisioning system; analyzing, using a resolution engine of the computing system, the identified characteristics of the potential fallout with respect to the at least one of the service order workflow, the business logic, or the business rules, and/or the like, to perform at least one of identifying one or more patterns or signatures of an identified potential fallout event, identifying one or more root causes of the identified potential fallout event, or generating a dynamic prioritization map for resolving the identified potential fallout event, and/or the like; generating and sending, using the computing system, one or more recommendations regarding the identified potential fallout event based on at least one of the identified patterns or signatures of the identified potential fallout event, the identified one or more root causes of the identified potential fallout event, or the generated dynamic prioritization map for resolving the identified potential fallout event, and/or the like; generating, using the computing system, additional dynamic POF data that simulates POF data corresponding to one or more additional potential fallout events occurring in the service order workflow across at least one of an application layer of the ordering and provisioning system or a network layer of the ordering and provisioning system; feeding, using the computing system, the generated additional dynamic POF data through a feedback loop; and repeating, a plurality of times with different dynamic POF data for each repetition, the processes of receiving the dynamic POF data, analyzing the dynamic POF data, analyzing the identified characteristics of the potential fallout, generating and sending the one or more recommendations, generating the additional dynamic POF data, and feeding the additional dynamic POF data through the feedback loop, to anticipate, and to recommend fixes for, additional potential fallout events before they occur.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing fallout identification, management, and resolution using a fallout management engine (“FAME”), in accordance with various embodiments.

FIG. 2 is a schematic block flow diagram illustrating a non-limiting example of a method of fallout identification and/or simulation, fallout pattern recognition, fallout cause determination, fallout resolution determination, and dynamic point of failure (“POF”) assignment that may be implemented during fallout identification, management, and resolution using FAME, in accordance with various embodiments.

FIG. 3 is a tabular diagram illustrating a non-limiting example of results in terms of efficacy of fallout identification, management, and resolution using FAME compared with manual operations for various order blockage types for a non-limiting use case, in accordance with various embodiments.

FIGS. 4A-4D are flow diagrams illustrating a method for implementing fallout identification, management, and resolution using a fallout management engine, in accordance with various embodiments.

FIG. 5 is a block diagram illustrating an example of computer or system hardware architecture, in accordance with various embodiments.

### DETAILED DESCRIPTION

Overview

Various embodiments provide tools and techniques for implementing fallout identification, management, and resolution, and, more particularly, to methods, systems, and apparatuses for implementing fallout identification, management, and resolution using a fallout management engine (“FAME”).

In various embodiments, a computing system may receive a first set of data associated with a service order workflow through an ordering and provisioning system, the service order workflow corresponding to ordering and provisioning of a service or a product that is provided or sold by a service provider; may analyze the first set of data to identify characteristics of fallout with respect to at least one of the service order workflow, business logic, or business rules, and/or the like, that are associated with the ordering and provisioning of the service or the product using the ordering and provisioning system, based on a learning model, wherein fallout may comprise at least one of a blockage, a break, or a disruption in the service order workflow with respect to at least one of one or more software components or one or more hardware components of the ordering and provisioning system; may analyze, using a resolution engine of the computing system, the identified characteristics of fallout with respect to the at least one of the service order workflow, the business logic, or the business rules, and/or the like, to perform at least one of identifying one or more patterns or signatures of an identified fallout event, identifying one or more root causes of the identified fallout event, or generating a dynamic prioritization map for resolving the identified fallout event, and/or the like; and may generate and send one or more recommendations regarding the identified fallout event based on at least one of the identified patterns or signatures of the identified fallout event, the identified one or more root causes of the identified fallout event, or the generated dynamic prioritization map for resolving the identified fallout event, and/or the like.

Alternatively, or additionally, a computing system may receive dynamic point of failure (“POF”) data that simulates POF data corresponding to one or more potential fallout events occurring in a service order workflow through an ordering and provisioning system, the service order workflow corresponding to ordering and provisioning of a service or a product that is provided or sold by a service provider; may analyze the dynamic POF data to identify characteristics of potential fallout with respect to at least one of the service order workflow, business logic, or business rules, and/or the like, that are associated with the ordering and provisioning of the service or the product using the ordering and provisioning system, based on a learning model, wherein the potential fallout may comprise at least one of a potential blockage, a potential break, or a potential disruption in the service order workflow with respect to at least one of one or more software components or one or more hardware components of the ordering and provisioning system; may analyze, using a resolution engine of the computing system, the identified characteristics of the potential fallout with respect to the at least one of the service order workflow, the business logic, or the business rules, and/or the like, to perform at least one of identifying one or more patterns or signatures of an identified potential fallout event, identifying one or more root causes of the identified potential fallout event, or generating a dynamic prioritization map for resolving the identified potential fallout event, and/or the like; may generate and send one or more recommendations regarding the identified potential fallout event based on at least one of the identified patterns or signatures of the identified potential fallout event, the identified one or more root causes of the identified potential fallout event, or the generated dynamic prioritization map for resolving the identified potential fallout event, and/or the like; may generate additional dynamic POF data that simulates POF data corresponding to one or more additional potential fallout events occurring in the service order workflow across at least one of an application layer of the ordering and provisioning system or a network layer of the ordering and provisioning system; may feed the generated additional dynamic POF data through a feedback loop; and may repeat, a plurality of times with different dynamic POF data for each repetition, the processes of receiving the dynamic POF data, analyzing the dynamic POF data, analyzing the identified characteristics of the potential fallout, generating and sending the one or more recommendations, generating the additional dynamic POF data, and feeding the additional dynamic POF data through the feedback loop, to anticipate, and to recommend fixes for, additional potential fallout events before they occur.

In the various aspects described herein, a system and methods are provided for implementing fallout identification, management, and resolution using a fallout management engine (“FAME”). FAME allows for independent and automatic identification, management, and resolution of potential fallout before its occurrence. FAME also allows for a learning model for prediction and/or dynamic POF assignment for real-time changes in workflow rules, resolution, and estimation. In some cases, FAME may further enable deep dive ability to learn business logic across end-to-end (“E2E”) workflows and devise rules, enable smart analysis of fallout failures and automated fixing followed by root cause determination, enable dynamic POF assessment and resolution, and enable real-time dynamic prioritization recommendation, and/or the like.

Fallout identification, management, and resolution using FAME may result in improved customer retention and revenue gain from a financial perspective; as well as reduced data quality issues and automated reconciliation from a user or employee experience perspective; in addition to higher customer satisfaction, data quality at portal, and turnaround from a customer experience perspective; and service scalability and self-learning, minimal touchpoints, and operational efficiencies from an efficiency improvement perspective.

These and other aspects of the system and method for implementing fallout identification, management, and resolution using FAME are described in greater detail with respect to the figures.

The following detailed description illustrates a few embodiments in further detail to enable one of skill in the art to practice such embodiments. The described examples are provided for illustrative purposes and are not intended to limit the scope of the invention.

In the following description, for the purposes of explanation, numerous details are set forth in order to provide a thorough understanding of the described embodiments. It will be apparent to one skilled in the art, however, that other embodiments of the present invention may be practiced without some of these details. In other instances, some structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments as described herein—while embodying (in some cases) software products, computer-performed methods, and/or computer systems—represent tangible, concrete improvements to existing technological areas, including, without limitation, fallout resolution technology, fallout identification technology, fallout management technology, fallout resolution technology, fallout prediction/identification, management, and resolution technology, service order management technology, product order management technology, workflow management technology, automated resolution technology, POF Assignment technology, and/or the like. In other aspects, some embodiments can improve the functioning of user equipment or systems themselves (e.g., fallout resolution systems, fallout identification systems, fallout management systems, fallout resolution systems, fallout prediction/identification, management, and resolution systems, service order management systems, product order management systems, workflow management systems, automated resolution systems, POF Assignment systems, etc.), for example, by receiving, using a computing system, a first set of data associated with a service order workflow through an ordering and provisioning system, the service order workflow corresponding to ordering and provisioning of a service or a product that is provided or sold by a service provider; analyzing, using the computing system, the first set of data to identify characteristics of fallout with respect to at least one of the service order workflow, business logic, or business rules that are associated with the ordering and provisioning of the service or the product using the ordering and provisioning system, based on a learning model, wherein fallout comprises at least one of a blockage, a break, or a disruption in the service order workflow with respect to at least one of one or more software components or one or more hardware components of the ordering and provisioning system; analyzing, using a resolution engine of the computing system, the identified characteristics of fallout with respect to the at least one of the service order workflow, the business logic, or the business rules to perform at least one of identifying one or more patterns or signatures of an identified fallout event, identifying one or more root causes of the identified fallout event, or generating a dynamic prioritization map for resolving the identified fallout event; and generating and sending, using the computing system, one or more recommendations regarding the identified fallout event based on at least one of the identified patterns or signatures of the identified fallout event, the identified one or more root causes of the identified fallout event, or the generated dynamic prioritization map for resolving the identified fallout event; and/or the like.

In particular, to the extent any abstract concepts are present in the various embodiments, those concepts can be implemented as described herein by devices, software, systems, and methods that involve novel functionality (e.g., steps or operations), such as, independent and automatic identification, management, and resolution of potential fallout before its occurrence; training and updating a learning model for prediction and/or dynamic POF assignment for real-time changes in workflow rules, resolution, and estimation; enabling deep dive ability to learn business logic across end-to-end (“E2E”) workflows and devise rules; enabling smart analysis of fallout failures and automated fixing followed by root cause determination; enabling dynamic POF assessment and resolution; and enabling real-time dynamic prioritization recommendation, and/or the like, to name a few examples, that extend beyond mere conventional computer processing operations. These functionalities can produce tangible results outside of the implementing computer system, including, merely by way of example, optimized ordering and provisioning platform or system, at least some of which may be observed or measured by users or customers, service providers, and/or merchants or vendors.

Some Embodiments

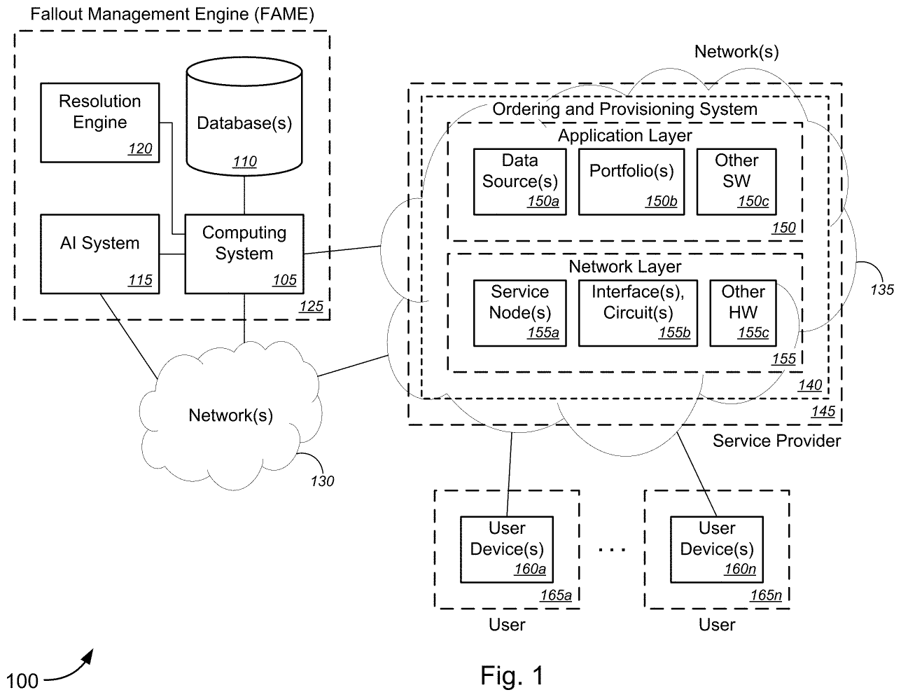

We now turn to the embodiments as illustrated by the drawings. FIGS. 1-5 illustrate some of the features of the method, system, and apparatus for implementing fallout identification, management, and resolution, and, more particularly, to methods, systems, and apparatuses for implementing fallout identification, management, and resolution using a fallout management engine (“FAME”), as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 is a schematic diagram illustrating a system 100 for implementing fallout identification, management, and resolution using a fallout management engine (“FAME”), in accordance with various embodiments.

In the non-limiting embodiment of FIG. 1, system 100 may comprise a computing system 105 and a database(s) 110 that is local to the computing system 105. In some cases, the database(s) 110 may be external, yet communicatively coupled, to the computing system 105. In other cases, the database(s) 110 may be integrated within the computing system 105. System 100, according to some embodiments, may further comprise an artificial intelligence (“AI”) system 115 and a resolution engine 120. In some instances, the computing system 105, the database(s) 110, the AI system 115, and the resolution engine 120 may be part of a fallout management engine (“FAME”) 125. In some alternative embodiments, although not shown, the computing system 105 may include, without limitation, at least one of the FAME 125, the resolution engine 120, the AI system 115, a machine learning system, a deep learning system, a server computer over a network, a cloud computing system, or a distributed computing system, and/or the like.

System 100 may further comprise one or more networks 130 and one or more networks 135. In some cases, the one or more networks 130 and the one or more networks 135 may be the same one or more networks or networks associated with the same service provider(s). Alternatively, the one or more networks 130 and the one or more networks 135 may be different one or more networks or networks associated with the different service providers. According to some embodiments, network(s) 130 and/or 135 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 130 and/or 135 may include an access network of the service provider (e.g., an Internet service provider (“ISP”)). In another embodiment, the network(s) 130 and/or 135 may include a core network of the service provider and/or the Internet.

System 100 may further comprise an ordering and provisioning platform or system 140 that is associated with a service provider 145. Although FIG. 1 depicts the ordering and provisioning system 140 being disposed within network(s) 135, the various embodiments are not so limited and, in some cases, ordering and provisioning system 140 may be disposed within network(s) 130 and/or network(s) 135, or the like. In some instances, service provider 145 may be the same service provider as the network service provider that provides network services, such as network services using network(s) 130 and/or 135. Alternatively, service provider 145 may be separate from the network service provider, although the ordering and provisioning system 140 may utilize network resources provided by the network service provider. In some embodiments, the ordering and provisioning system 140 may include, but is not limited to, at least one of an application layer (e.g., application layer 150, or the like) or a network layer (e.g., network layer 155, or the like).

In some instances, application layer 150 may include, without limitation, at least one of one or more data sources 150a, one or more portfolios 150b, or one or more other software (“SW”) components 150c, and/or the like. According to some embodiments, the one or more data sources 150a may include, but are not limited to, at least one of one or more event data sources, one or more point of failure (“POF”) data sources, one or more information technology service management (“ITSM”) data sources, one or more workflow event data sources, or one or more other data sources, and/or the like. In some cases, the one or more event data sources may include, without limitation, at least one of one or more real-time event data sources, one or more logged event data sources, or one or more simulated event data sources, and/or the like. In some instances, the one or more POF data sources may include, without limitation, at least one of one or more static POF data sources, one or more dynamic POF data sources, one or more actual POF data sources, or one or more simulated POF data sources, and/or the like. In some cases, the one or more workflow event data sources may include, without limitation, at least one of one or more ordering and provisioning system workflow event data sources, one or more business workflow event data sources, one or more service workflow event data sources, or one or more order workflow event data sources, and/or the like. In some instances, the one or more other data sources may include, without limitation, at least one of one or more service order management input data sources, one or more product order management input data sources, one or more service order incident data sources, one or more product order incident data sources, one or more warning data sources, one or more event log data sources, one or more error data sources, one or more alert data sources, one or more human resources input data sources, one or more service team input data sources, or one or more sales team input data sources, and/or the like.

In some cases, network layer 155 may include, but is not limited to, at least one of one or more nodes or service nodes 155a, one or more interfaces and/or circuits 155b, or one or more other hardware (“HW”) components 155c, and/or the like. According to some embodiments, the one or more service nodes 155a may include, without limitation, nodes, devices, machines, or systems, and/or the like, that may be used to perform one or more services provided by a service provider to customers.

Merely by way of example, in some cases, system 100 may further comprise one or more user devices 160a-160n (collectively, “user devices 160” or the like) that are associated with corresponding users 165a-165n (collectively, “users 165” or the like). According to some embodiments, the one or more user devices 160 may each include, but is not limited to, one of a laptop computer, a desktop computer, a service console, a technician portable device, a tablet computer, a smart phone, a mobile phone, and/or the like. In some embodiments, the one or more users 165 may each include, without limitation, at least one of one or more customers, one or more service agents, one or more service technicians, one or more service management agents, or one or more sales representatives, and/or the like.

In operation, computing system 105, AI system 115, resolution engine 120, and/or FAME 125 (collectively, “computing system” or the like) may receive a first set of data associated with a service order workflow through an ordering and provisioning system (e.g., ordering and provisioning system 140, or the like), the service order workflow corresponding to ordering and provisioning of a service or a product that is provided or sold by a service provider (e.g., service provider 145, or the like). In some cases, the first set of data may include, but is not limited to, at least one of event data, real-time event data, logged event data, simulated event data, POF data, static POF data, dynamic POF data, actual POF data, simulated POF data, ITSM data, workflow event data, ordering and provisioning system workflow event data, business workflow event data, service workflow event data, order workflow event data, service order management input data, product order management input data, service order incident data, product order incident data, warning data, event log data, error data, alert data, human resources input data, service team input data, or sales team input data, and/or the like.

The computing system may analyze the first set of data to identify characteristics of fallout with respect to at least one of the service order workflow, business logic, or business rules, and/or the like, that are associated with the ordering and provisioning of the service or the product using the ordering and provisioning system, based on a learning model (e.g., a learning model within AI system 115, or the like). In some cases, fallout may include, but is not limited to, at least one of a blockage, a break, or a disruption in the service order workflow with respect to at least one of one or more software components (e.g., components within application layer 150, including, but not limited to, data source(s) 150a, portfolio(s) 150b, and/or other SW components 150c, and/or the like) or one or more hardware components (e.g., components within network layer 155, including, but not limited to, service node(s) 155a, interface(s) and/or circuit(s) 155b, and/or other HW components 155c, and/or the like) of the ordering and provisioning system (e.g., ordering and provisioning system 140, or the like).

The computing system (e.g., using resolution engine 120, or the like) may analyze the identified characteristics of fallout with respect to the at least one of the service order workflow, the business logic, or the business rules, and/or the like, to perform at least one of identifying one or more patterns or signatures of an identified fallout event, identifying one or more root causes of the identified fallout event, or generating a dynamic prioritization map for resolving the identified fallout event, and/or the like. According to some embodiments, performing the at least one of identifying the one or more patterns or signatures of the identified fallout event, identifying the one or more root causes of the identified fallout event, or generating the dynamic prioritization map for resolving the identified fallout event, and/or the like, may occur in real-time or near-real-time. In some cases, the identified patterns or signatures may be real-time or near-real-time patterns or signatures of the identified fallout event, the identified one or more root causes may be real-time or near-real-time root causes of the identified fallout event, or the generated dynamic prioritization map may be a real-time or near-real-time dynamic prioritization map for resolving the identified fallout event.

The computing system may generate one or more recommendations regarding the identified fallout event based on at least one of the identified patterns or signatures of the identified fallout event, the identified one or more root causes of the identified fallout event, or the generated dynamic prioritization map for resolving the identified fallout event, and/or the like. The computing system may subsequently send the one or more recommendations, e.g., to a user (e.g., to user device(s) 160 associated with corresponding user(s) 165, or the like).

In some embodiments, the first set of data may include, without limitation, at least one of end-to-end (“E2E”) data associated with the entire service order workflow across an application layer (e.g., application layer 150, or the like) of the ordering and provisioning system (e.g., ordering and provisioning system 140, or the like) or E2E data associated with the entire service order workflow across a network layer (e.g., network layer 155, or the like) of the ordering and provisioning system (e.g., ordering and provisioning system 140, or the like), and/or the like. In such cases, analyzing the first set of data to identify the characteristics of fallout with respect to the at least one of the service order workflow, the business logic, or the business rules, and/or the like, may comprise the computing system analyzing the first set of data to identify characteristics of fallout across the entire service order workflow across at least one of the application layer or the network layer, and/or the like, with respect to at least one of the service order workflow, business logic, or business rules, and/or the like, that are associated with the ordering and provisioning of the service or the product using the ordering and provisioning system, based on the learning model. In some cases, the E2E data associated with the entire service order workflow across the application layer of the ordering and provisioning system may include, but is not limited to, E2E data associated with the entire application layer, while the E2E data associated with the entire service order workflow across the network layer of the ordering and provisioning system may include, without limitation, E2E data associated with the entire network layer. In some instances, the one or more software components may be associated with the application layer, while the one or more hardware components may be associated with the network layer. In some cases, E2E workflow analysis may also enable fallout identification, management, and resolution even in the case that the ordering and provisioning system utilizes legacy equipment (which may traditionally be difficult to diagnose in a manner consistent with more recently implemented equipment in terms of fallout, or the like).

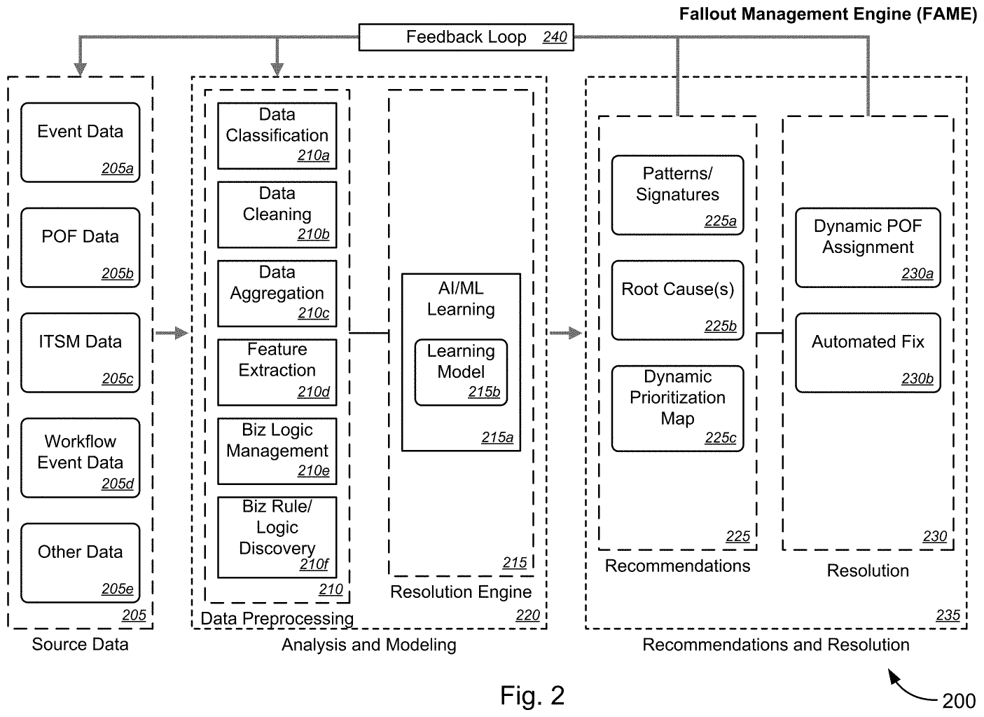

The computing system may generate dynamic POF data that simulates POF data corresponding to one or more potential fallout events occurring in the service order workflow across at least one of an application layer of the ordering and provisioning system or a network layer of the ordering and provisioning system. The computing system may feed the generated dynamic POF data through a feedback loop (such as shown in FIG. 2, or the like). The processes of receiving the first set of data, analyzing the first set of data, analyzing the identified characteristics of fallout, and generating and sending the one or more recommendations may be repeated with the generated dynamic POF data fed back through the feedback loop, to anticipate, and to recommend fixes for, potential fallout events before they occur. In some instances, the processes of generating the dynamic POF data, feeding the generated dynamic POF data through the feedback loop, receiving the first set of data, analyzing the first set of data, analyzing the identified characteristics of fallout, and generating and sending the one or more recommendations may be repeated one or more times with different dynamic POF data being generated and used as the first set of data for each repetition, to anticipate, and to recommend fixes for, additional potential fallout events before they occur.

In this manner, the system can, in some cases, continually “test” the application layer (and/or SW components) and/or the network layer (and/or HW components) of the ordering and provisioning system to “temper” the ordering and provisioning system, by purposely introducing pseudo POF data through the feedback loop and moving new or different pseudo POF data with each successive repetition or loop to other parts of the service order workflow, thereby causing the computing system (e.g., resolution engine 120, AI system 115, and/or FAME 125 as a whole, or the like) to identify patterns and/or signatures of potential fallout events, to identify root causes of potential fallout events, and/or to generate dynamic prioritization maps for resolving potential fallout events, and/or the like, corresponding to each pseudo POF data at the corresponding locations within the service order workflow, or the like, in some cases, doing so in an E2E manner as described above. Herein, “dynamic” in “dynamic POF data” may refer to the shifting of the pseudo POF data to different locations within the service order workflow (e.g., at order capture, at order creation, at order provisioning, or at order completion, and/or the like) with each successive loop or repetition through the feedback loop.

In some embodiments, the computing system may determine a tolerance level for a class of service or product associated with the service or product that is provided or sold by the service provider. The computing system may determine a confidence level corresponding to at least one of a level of confidence that the identified patterns or signatures correspond to actual patterns or signatures of the identified fallout event, a level of confidence that the identified one or more root causes correspond to actual root causes of the identified fallout event, or a level of confidence that the generated dynamic prioritization map corresponds to a viable dynamic prioritization map for resolving the identified fallout event, and/or the like. The computing system may determine whether the determined confidence level exceeds the determined tolerance level for the class of service or product associated with the service or product that is provided or sold by the service provider. If so, the computing system may generate one or more automated repair protocols, and may implement the one or more automated repair protocols. In some embodiments, the one or more automated repair protocols may include, but are not limited to, at least one of one or more new business logic, one or more new business rules, a new service order workflow, one or more automated fixes to one or more existing business logic, one or more automated fixes to one or more existing business rules, or one or more automated fixes to the service order workflow, and/or the like. For example, for banking services, medical services, or any real-time or urgent classes of services or products, or the like, the computing system may initially determine that the corresponding tolerance level is high (e.g., 99.999%). In such cases, it is unlikely that the determined confidence level is sufficiently high to satisfy the above-described conditions for automated repair operations. On the other hand, for less critical classes of services or products (e.g., telecommunications services and/or products, or the like), the computing system may initially determine that the corresponding tolerance level is moderate (e.g., 50-75%, or the like). In such cases, if the determined confidence level is sufficiently high to exceed this moderate tolerance level (e.g., a level between 80 and 95%, or the like), then the computing system may proceed with implementing automated repair operations in an autonomous manner. With successive iterations and feedback looping, and the like, the tolerance level for a subject class of service or product may decrease over time and/or repetition, and/or the corresponding confidence level for the predictions and/or recommendations may increase over time and/or repetition, particularly with generation of improved or enhanced rules and/or logic (and, in some cases, improved or enhanced service order workflows as well), or the like.

According to some embodiments, analyzing the first set of data to identify the characteristics of fallout with respect to the at least one of the service order workflow, the business logic, or the business rules, and/or the like, may comprise the computing system: performing data classification on the first set of data, by providing data labelling to the first set of data based at least in part on type of data; performing data cleaning on the first set of data based at least in part on the data classification to produce a second set of data, the second set of data including, without limitation, at least one of data associated with the service order workflow, data associated with a fallout event, or event data, and/or the like, without private data associated with a customer and without customer proprietary data, or the like; performing data aggregation on the second set of data to produce aggregated data for each of the at least one of the data associated with the service order workflow, the data associated with the fallout event, or the event data, and/or the like, based at least in part on data labelling and data classification; performing feature extraction on the aggregated data to identify at least one of key features or attributes of data associated with the service order workflow from among the aggregated data; analyzing, using a business logic manager of the computing system, the identified at least one of key features or attributes of the data associated with the service order workflow from among the aggregated data to identify at least one of one or more business logic or one or more business rules that either are impacted by the identified fallout event or are contributing to occurrence of the identified fallout event; and identifying, using the learning model, the characteristics of fallout with respect to the at least one of the service order workflow, the business logic, or the business rules, and/or the like, based at least in part on the identified at least one of key features or attributes of the data associated with the service order workflow from among the aggregated data and the identified at least one of one or more business logic or one or more business rules that either are impacted by the identified fallout event or are contributing to occurrence of the identified fallout event.

In some instances, the learning model may be an artificial intelligence (“AI”) model. In such cases, the computing system may update the learning model to improve identification of the characteristics of fallout with respect to the at least one of the service order workflow, the business logic, or the business rules, and/or the like, based at least in part on any changes to the characteristics of fallout with respect to the at least one of the service order workflow, the business logic, or the business rules, and/or the like, due to one or more of the identified at least one of key features or attributes of the data associated with the service order workflow from among the aggregated data or the identified at least one of one or more business logic or one or more business rules that either are impacted by the identified fallout event or are contributing to occurrence of the identified fallout event, and/or the like.

Alternatively, or additionally, in some aspects, the computing system may receive dynamic POF data that simulates POF data corresponding to one or more potential fallout events occurring in the service order workflow through the ordering and provisioning system, the service order workflow corresponding to ordering and provisioning of a service or a product that is provided or sold by a service provider. The computing system may analyze the dynamic POF data to identify characteristics of potential fallout with respect to at least one of the service order workflow, business logic, or business rules, and/or the like, that are associated with the ordering and provisioning of the service or the product using the ordering and provisioning system, based on a learning model. In some instances, the potential fallout may include, but is not limited to, at least one of a potential blockage, a potential break, or a potential disruption in the service order workflow with respect to at least one of one or more software components or one or more hardware components of the ordering and provisioning system.

The computing system (in some cases, using resolution engine 120, or the like) may analyze the identified characteristics of the potential fallout with respect to the at least one of the service order workflow, the business logic, or the business rules, and/or the like, to perform at least one of identifying one or more patterns or signatures of an identified potential fallout event, identifying one or more root causes of the identified potential fallout event, or generating a dynamic prioritization map for resolving the identified potential fallout event, and/or the like.

The computing system may generate one or more recommendations regarding the identified potential fallout event based on at least one of the identified patterns or signatures of the identified potential fallout event, the identified one or more root causes of the identified potential fallout event, or the generated dynamic prioritization map for resolving the identified potential fallout event, and/or the like. The computing system may subsequently send the one or more recommendations, e.g., to a user (e.g., to user device(s) 160 associated with corresponding user(s) 165, or the like).

The computing system may generate additional dynamic POF data that simulates POF data corresponding to one or more additional potential fallout events occurring in the service order workflow across at least one of an application layer of the ordering and provisioning system or a network layer of the ordering and provisioning system. The computing system may feed the generated additional dynamic POF data through a feedback loop, similar to the feedback loop processes as described above. Similar to those processes described above, the processes of receiving the dynamic POF data, analyzing the dynamic POF data, analyzing the identified characteristics of the potential fallout, generating and sending the one or more recommendations, generating the additional dynamic POF data, and feeding the additional dynamic POF data through the feedback loop, may be repeated with the generated dynamic POF data fed back through the feedback loop, to anticipate, and to recommend fixes for, potential fallout events before they occur. In some instances, the processes of generating the dynamic POF data, feeding the generated dynamic POF data through the feedback loop, receiving the first set of data, analyzing the first set of data, analyzing the identified characteristics of fallout, and generating and sending the one or more recommendations may be repeated a plurality of times with different dynamic POF data for each repetition, to anticipate, and to recommend fixes for, additional potential fallout events before they occur. These processes with the dynamic POF data feedback loops are otherwise similar, if not identical, to the processes described above with respect to the first set of data in general.

These and other functions of the system 100 (and its components) are described in greater detail below with respect to FIGS. 2-4.

FIG. 2 is a schematic block flow diagram illustrating a non-limiting example of a method 200 of fallout identification and/or simulation, fallout pattern recognition, fallout cause determination, fallout resolution determination, and dynamic POF assignment that may be implemented during fallout identification, management, and resolution using FAME, in accordance with various embodiments.

With reference to FIG. 2, fallout identification and/or simulation, fallout pattern recognition, fallout cause determination, fallout resolution determination, and dynamic POF assignment, such as described above with respect to FIG. 1 or the like, may utilize source data 205, including, but not limited to, at least one of event data 205a, POF data 205b, ITSM data 205c, workflow event data 205d, or other data 205e, and/or the like. In some cases, the event data 205a may include, without limitation, at least one of real-time event data, logged event data, or simulated event data, and/or the like. In some instances, the POF data 205b may include, without limitation, at least one of static POF data, dynamic POF data, actual POF data, or simulated POF data, and/or the like. In some cases, the workflow event data 205d may include, without limitation, at least one of ordering and provisioning system workflow event data, business workflow event data, service workflow event data, or order workflow event data, and/or the like. In some instances, the other data 205e may include, without limitation, at least one of service order management input data, product order management input data, service order incident data, product order incident data, warning data, event log data, error data, alert data, human resources input data, service team input data, or sales team input data, and/or the like. In some instances, data of two or more of event data 205a, POF data 205b, ITSM data 205c, workflow event data 205d, or other data 205e may overlap or may be the same set of data. In other cases, data of event data 205a, POF data 205b, ITSM data 205c, workflow event data 205d, or other data 205e may be different yet related.

According to some embodiments, the event data 205a may include data corresponding to events affecting service order workflow (which is as described above with respect to FIG. 1, or the like), such events including, but not limited to fallout events, congestion events, etc. The POF data 205b may include data corresponding to a point(s) of failure in or within the service order workflow, and/or the like. The ITSM data 205c may include data pertaining to service management and/or operations associated with the information technology components for providing the ordering and provisioning platform or system functionalities. The workflow event data 205d may include data corresponding to workflow events not limited to particular fallout events or congestion events, etc. Various ones of the other data 205e include the following. The service order management input data and/or the product order management input data may include data that may be used to monitor, diagnose, track, and/or affect the service provided to customers for ordering services and/or products, while the service order incident data and/or the product order incident data may include data that corresponds to service order incidents and/or product order incidents (e.g., outages, errors, congestion, or the like, occurring during ordering of the services or products). The warning data may include data corresponding to warnings sent by SW and/or HW components (and/or the application layer and/or the network layer) of the ordering and provisioning system, or the like. The event log data may include data corresponding to event logs that track service events, or the like. The error data may include data corresponding to errors in ordering of services and/or products by the customer using the ordering and provisioning system and/or data corresponding to errors in provisioning the services and/or the products to the customers, while the alert data may include data that alerts service provider agents to current issues, current incidents, current events, potential issues, potential incidents, or potential events, and/or the like, with respect to functioning or operation of the ordering and provisioning system. The human resources (“HR”) input data may include data corresponding to personnel data of service agents and/or service technicians who may be enlisted to address issues or incidents that have occurred during ordering and/or provisioning of the services and/or products by or to the customers, while service team input data may include data that may be used by service team members or service team leaders to facilitate assignment of tasks for addressing issues or incidents that have occurred during ordering and/or provisioning of the services and/or products by or to the customers, or the like.

Data preprocessing 210 may be performed on the source data 205, the data preprocessing 210 including, without limitation, at least one of data classification 210a, data cleaning 210b, data aggregation 210c, feature extraction 210d, business logic management 210e, and/or business rule and/or logic discovery 210f, and/or the like. Resolution engine 215 may utilize artificial intelligence (“AI”) or machine learning (“ML”) learning or training 215a to train and update learning model 215b, and/or the like. Resolution engine 215 functionalities may be performed on the output of the data preprocessing 210, in some cases, using the learning model 215b. Data preprocessing 210 and resolution engine 215 may be part of analysis and modeling logic 220.

Data classification 210a may include performing classification of input data 205, by providing data labelling to the input data 205 based at least in part on type of data, or the like. Data cleaning 210b may include performing cleaning of input data 205, in some cases, based at least in part on the data classification to produce second set of data, where the second set of data may include, without limitation, the second set of data including, without limitation, at least one of data associated with the service order workflow, data associated with a fallout event, or event data, and/or the like, without private data associated with a customer and without customer proprietary data, or the like. Data aggregation 210c may include performing data aggregation on the second set of data to produce aggregated data for each of the at least one of the data associated with the service order workflow, the data associated with the fallout event, or the event data, and/or the like, based at least in part on data labelling and data classification. Feature extraction 210d may include performing extraction of features from the aggregated data to identify at least one of key features or attributes of data associated with the service order workflow from among the aggregated data. Business logic management 210e may be used to perform business rule and/or logic discovery 210f, by analyzing the identified at least one of key features or attributes of the data associated with the service order workflow from among the aggregated data to identify at least one of one or more business logic or one or more business rules that either are impacted by the identified fallout event or are contributing to occurrence of the identified fallout event.

Resolution engine 215 and/or AI/ML learning 215a may be used to identify, using the learning model 215b, the characteristics of fallout with respect to the at least one of the service order workflow, the business logic, or the business rules, and/or the like, based at least in part on the identified at least one of key features or attributes of the data associated with the service order workflow from among the aggregated data and the identified at least one of one or more business logic or one or more business rules that either are impacted by the identified fallout event or are contributing to occurrence of the identified fallout event. In some cases, Resolution engine 215 and/or AI/ML learning 215a may be used to update the learning model 215b to improve identification of the characteristics of fallout with respect to the at least one of the service order workflow, the business logic, or the business rules, and/or the like, based at least in part on any changes to the characteristics of fallout with respect to the at least one of the service order workflow, the business logic, or the business rules, and/or the like, due to one or more of the identified at least one of key features or attributes of the data associated with the service order workflow from among the aggregated data or the identified at least one of one or more business logic or one or more business rules that either are impacted by the identified fallout event or are contributing to occurrence of the identified fallout event, and/or the like.

Resolution engine 220 may also be used to generate (in some cases, using AI/ML learning 215a and/or learning model 215b, or the like) recommendations 225, including, but not limited to, identifying one or more patterns or signatures of an identified fallout event, identifying one or more root causes of the identified fallout event, or generating a dynamic prioritization map for resolving the identified fallout event, and/or the like, one or more of which may be performed in real-time or near-real-time. In some cases, the identified patterns or signatures may be real-time or near-real-time patterns or signatures of the identified fallout event, the identified one or more root causes may be real-time or near-real-time root causes of the identified fallout event, or the generated dynamic prioritization map may be a real-time or near-real-time dynamic prioritization map for resolving the identified fallout event. In some instances, the dynamic prioritization map may include, without limitation, map data for outlining which rules, logic, workflows to change and how to change, as well as in what optimal order, or the like.

Resolution 230 may be performed based on the recommendations 235, and may include, without limitation, dynamic POF assignment 230a and automated fix 230b, or the like. Recommendation 225 and resolution 230 may be part of the recommendation and resolution logic 235. Dynamic POF assignment 230a may include generating dynamic POF data that simulates POF data corresponding to one or more potential fallout events occurring in the service order workflow across at least one of an application layer of the ordering and provisioning system or a network layer of the ordering and provisioning system. The generated dynamic POF data may be fed through a feedback loop 240 to the source data 205 portion and/or the data preprocessing portion 210, and is as described in detail above with respect to FIG. 1. In some embodiments, recommendations 225 and/or automated fix 230 may also be fed through the feedback loop 240, as shown in FIG. 2. In some cases, automated fix 230 may include generation and implementation of one or more automated repair protocols, which may include, but are not limited to, at least one of one or more new business logic, one or more new business rules, a new service order workflow, one or more automated fixes to one or more existing business logic, one or more automated fixes to one or more existing business rules, or one or more automated fixes to the service order workflow, and/or the like. Automated fix 230 may be implemented autonomously if it is determined that a determined confidence level exceeds a determined tolerance level for a class of service or product associated with the service or product that is provided or sold by the service provider, as described in detail above with respect to FIG. 1.

These and other functions of the example(s) 200 (and its components) are described in greater detail herein with respect to FIGS. 1, 3, and 4.

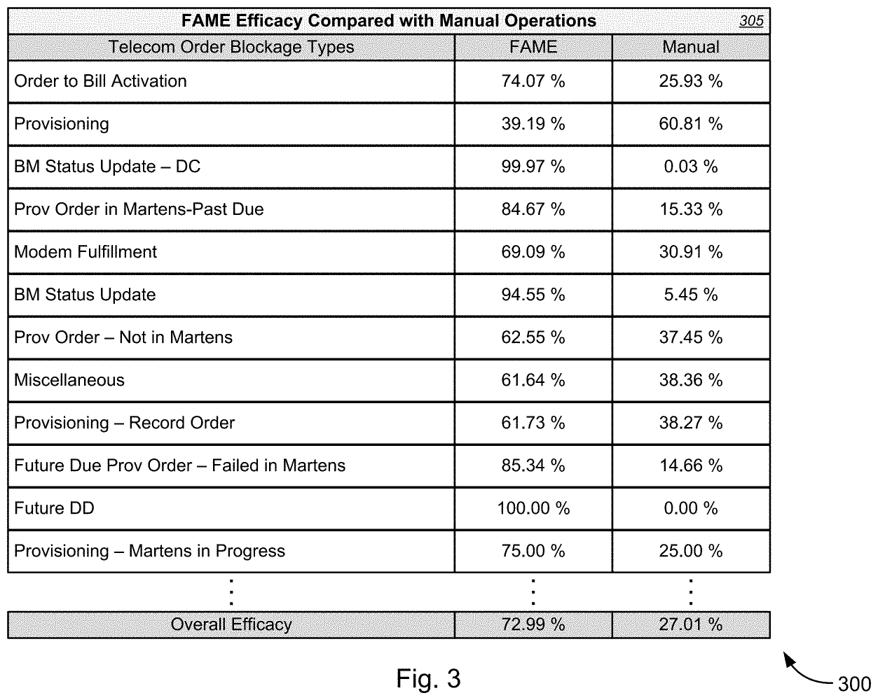

FIG. 3 is a tabular diagram illustrating a non-limiting example 300 of results in terms of efficacy of fallout identification, management, and resolution using FAME compared with manual operations for various order blockage types for a non-limiting use case, in accordance with various embodiments.

With reference to non-limiting example 300 of FIG. 3, FAME efficacy is compared with manual operations (at block 305). In this example, telecommunications order blockage types are shown together with measured efficacy of FAME (such as described herein with respect to FIGS. 1, 2, and 4, or the like) compared with manual operations, in terms of efficacy of recommendations (e.g., recommendations 225 and corresponding components described with respect to FIGS. 1, 2, and 4, or the like) for identifying patterns/signatures of (actual or potential) fallout events, identifying root causes for (actual or potential) fallout events, and resolving (actual or potential) fallout events. These values may also take into account comparisons between resolution (e.g., resolution 230 and corresponding components described with respect to FIGS. 1, 2, and 4, or the like) for implementing dynamic POF assignment (e.g., dynamic POF assignment 230a and corresponding functionality described with respect to FIGS. 1, 2, and 4, or the like) and/or automated fix (e.g., automated fix 230b and corresponding functionality described with respect to FIGS. 1, 2, and 4, or the like) and manual operations for addressing the order blockage types. In the telecommunications use case, over 40 key business rules may be successfully running, which may contribute to the ˜73% overall efficacy of FAME.

Although FIG. 3 depicts a telecommunications use case, the various embodiments are not so limited, and FAME may be applicable to any suitable service and/or product ordering and provisioning workflow system or platform, and may be applicable to such classes of services or products as banking service, medical services, online retail services, network-based ordering and/or provisioning services, or the like.

These and other functions of FAME (and its components) are described in greater detail herein with respect to FIGS. 1, 2, and 4.

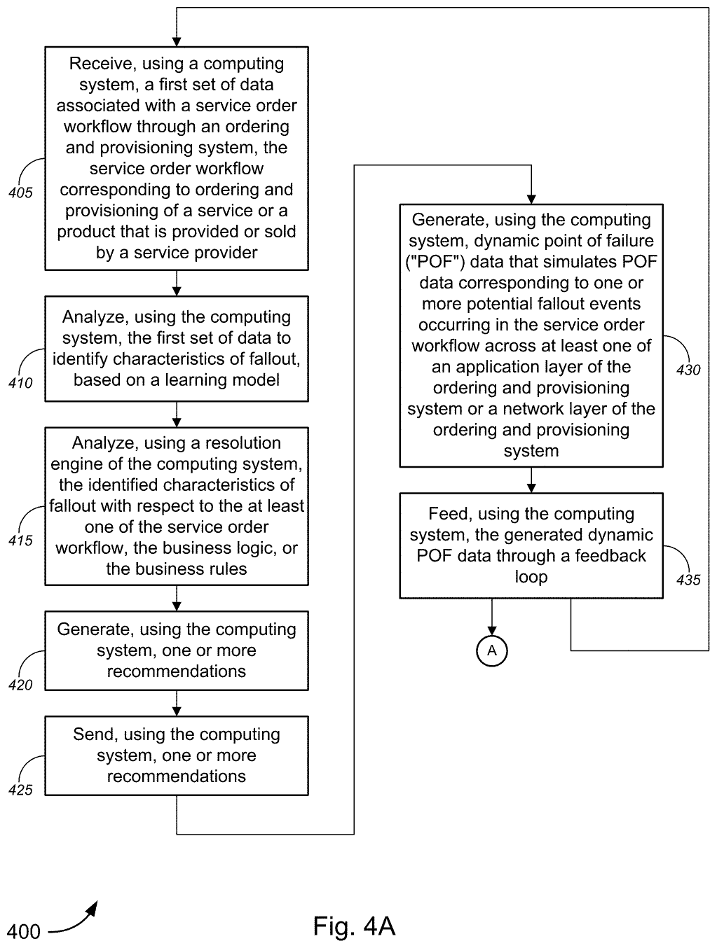

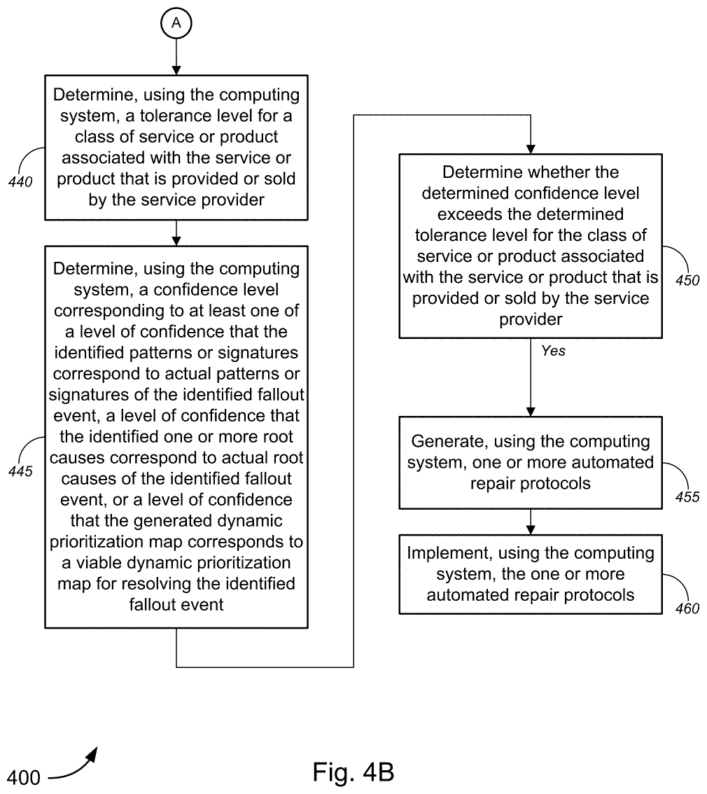

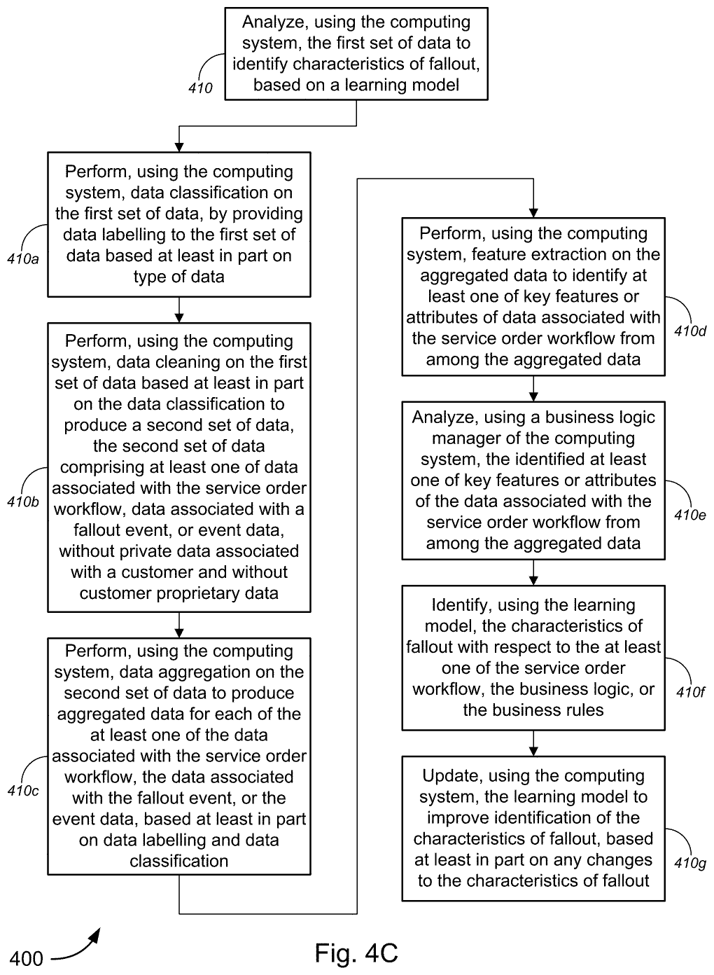

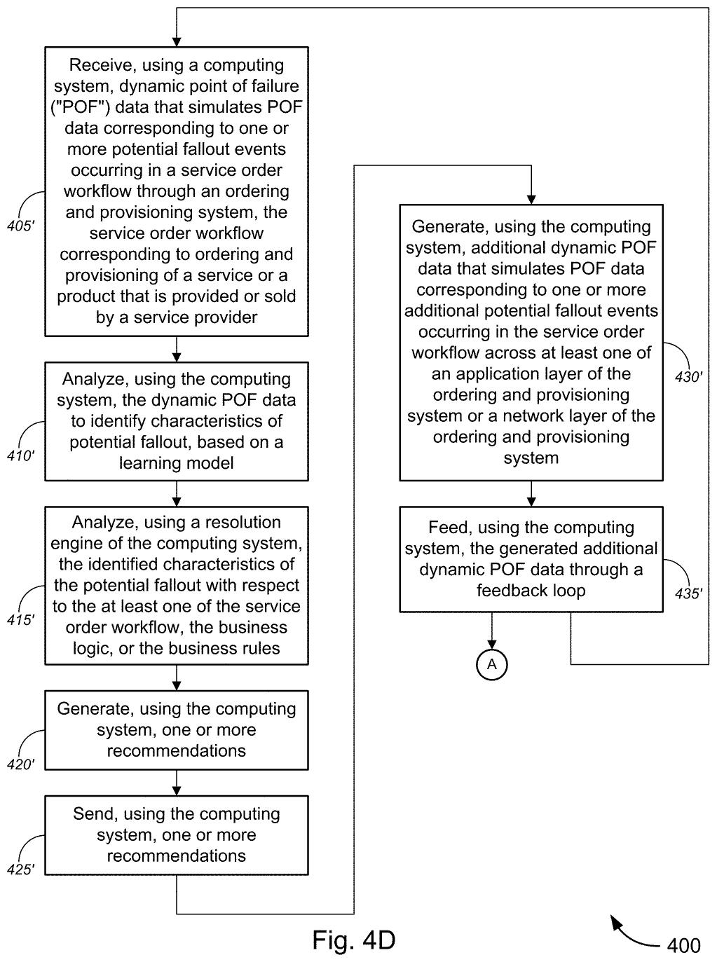

FIGS. 4A-4D (collectively, “FIG. 4”) are flow diagrams illustrating a method 400 for implementing fallout identification, management, and resolution using a fallout management engine, in accordance with various embodiments. Method 400 of FIG. 4A continues onto FIG. 4B following the circular marker denoted, “A.” Method 400 of FIG. 4D also continues onto FIG. 4B following the circular marker denoted, “A.”

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, and 300 of FIGS. 1, 2, and 3, respectively (or components thereof), can operate according to the method 400 illustrated by FIG. 4 (e.g., by executing instructions embodied on a computer readable medium), the systems, examples, or embodiments 100, 200, and 300 of FIGS. 1, 2, and 3 can each also operate according to other modes of operation and/or perform other suitable procedures.

In the non-limiting embodiment of FIG. 4A, method 400, at block 405, may comprise receiving, using a computing system, a first set of data associated with a service order workflow through an ordering and provisioning system, the service order workflow corresponding to ordering and provisioning of a service or a product that is provided or sold by a service provider.

In some embodiments, the computing system may include, without limitation, at least one of a fallout management engine (“FAME”), an artificial intelligence (“AI”) system, a machine learning system, a deep learning system, a server computer over a network, a cloud computing system, or a distributed computing system, and/or the like. In some cases, the first set of data may include, but is not limited to, at least one of event data, real-time event data, logged event data, simulated event data, point of failure (“POF”) data, static POF data, dynamic POF data, actual POF data, simulated POF data, information technology service management (“ITSM”) data, workflow event data, ordering and provisioning system workflow event data, business workflow event data, service workflow event data, order workflow event data, service order management input data, product order management input data, service order incident data, product order incident data, warning data, event log data, error data, alert data, human resources input data, service team input data, or sales team input data, and/or the like.

At block 410, method 400 may comprise analyzing, using the computing system, the first set of data to identify characteristics of fallout with respect to at least one of the service order workflow, business logic, or business rules, and/or the like, that are associated with the ordering and provisioning of the service or the product using the ordering and provisioning system, based on a learning model. In some cases, fallout may include, but is not limited to, at least one of a blockage, a break, or a disruption in the service order workflow with respect to at least one of one or more software components or one or more hardware components of the ordering and provisioning system.

Method 400 may further comprise, at block 415, analyzing, using a resolution engine of the computing system, the identified characteristics of fallout with respect to the at least one of the service order workflow, the business logic, or the business rules, and/or the like, to perform at least one of identifying one or more patterns or signatures of an identified fallout event, identifying one or more root causes of the identified fallout event, or generating a dynamic prioritization map for resolving the identified fallout event, and/or the like. According to some embodiments, performing the at least one of identifying the one or more patterns or signatures of the identified fallout event, identifying the one or more root causes of the identified fallout event, or generating the dynamic prioritization map for resolving the identified fallout event, and/or the like, may occur in real-time or near-real-time. In some cases, the identified patterns or signatures may be real-time or near-real-time patterns or signatures of the identified fallout event, the identified one or more root causes may be real-time or near-real-time root causes of the identified fallout event, or the generated dynamic prioritization map may be a real-time or near-real-time dynamic prioritization map for resolving the identified fallout event.

Method 400 may further comprise generating, using the computing system, one or more recommendations regarding the identified fallout event based on at least one of the identified patterns or signatures of the identified fallout event, the identified one or more root causes of the identified fallout event, or the generated dynamic prioritization map for resolving the identified fallout event, and/or the like (block 420); and sending, using the computing system, the one or more recommendations, e.g., to a user (e.g., to user device(s) 160 associated with corresponding user(s) 165 in FIG. 1, or the like) (block 425).

In some embodiments, the first set of data may include, without limitation, at least one of end-to-end (“E2E”) data associated with the entire service order workflow across an application layer of the ordering and provisioning system or E2E data associated with the entire service order workflow across a network layer of the ordering and provisioning system, and/or the like. In such cases, analyzing the first set of data to identify the characteristics of fallout with respect to the at least one of the service order workflow, the business logic, or the business rules, and/or the like, (at block 410) may comprise analyzing, using the computing system, the first set of data to identify characteristics of fallout across the entire service order workflow across at least one of the application layer or the network layer, and/or the like, with respect to at least one of the service order workflow, business logic, or business rules, and/or the like, that are associated with the ordering and provisioning of the service or the product using the ordering and provisioning system, based on the learning model. In some cases, the E2E data associated with the entire service order workflow across the application layer of the ordering and provisioning system may include, but is not limited to, E2E data associated with the entire application layer, while the E2E data associated with the entire service order workflow across the network layer of the ordering and provisioning system may include, without limitation, E2E data associated with the entire network layer. In some instances, the one or more software components may be associated with the application layer, while the one or more hardware components may be associated with the network layer.

At block 430, method 400 may comprise generating, using the computing system, dynamic point of failure (“POF”) data that simulates POF data corresponding to one or more potential fallout events occurring in the service order workflow across at least one of an application layer of the ordering and provisioning system or a network layer of the ordering and provisioning system. Method 400 may further comprise, at block 435, feeding, using the computing system, the generated dynamic POF data through a feedback loop. Method 400 may return to the process at block 405, and may repeat the processes of receiving the first set of data (at block 405), analyzing the first set of data (at block 410), analyzing the identified characteristics of fallout (at block 415), and generating (at block 420) and sending (at block 425) the one or more recommendations, to anticipate, and to recommend fixes for, potential fallout events before they occur, where the first set of data in the feedback loop may include, without limitation, the generated dynamic POF data. In some instances, the processes of generating the dynamic POF data (at block 430), feeding the generated dynamic POF data through the feedback loop (at block 435), receiving the first set of data (at block 405), analyzing the first set of data (at block 410), analyzing the identified characteristics of fallout (at block 415), and generating (at block 420) and sending (at block 425) the one or more recommendations may be repeated one or more times with different dynamic POF data being generated and used as the first set of data for each repetition, to anticipate, and to recommend fixes for, additional potential fallout events before they occur. Alternatively, or additionally, method 400 may continue onto the process at block 440 in FIG. 4B following the circular marker denoted, “A.”

At block 440 in FIG. 4B (following the circular marker denoted, “A”), method 400 may comprise determining, using the computing system, a tolerance level for a class of service or product associated with the service or product that is provided or sold by the service provider. Method 400, at block 445, may comprise determining, using the computing system, a confidence level corresponding to at least one of a level of confidence that the identified patterns or signatures correspond to actual patterns or signatures of the identified fallout event, a level of confidence that the identified one or more root causes correspond to actual root causes of the identified fallout event, or a level of confidence that the generated dynamic prioritization map corresponds to a viable dynamic prioritization map for resolving the identified fallout event, and/or the like. Method 400 may further comprise, at block 450, determining whether the determined confidence level exceeds the determined tolerance level for the class of service or product associated with the service or product that is provided or sold by the service provider. If so, method 400 may further comprise generating, using the computing system, one or more automated repair protocols (block 455), and implementing, using the computing system, the one or more automated repair protocols (block 460). In some embodiments, the one or more automated repair protocols may include, but are not limited to, at least one of one or more new business logic, one or more new business rules, a new service order workflow, one or more automated fixes to one or more existing business logic, one or more automated fixes to one or more existing business rules, or one or more automated fixes to the service order workflow, and/or the like.

Turning to the non-limiting embodiment of FIG. 4C, analyzing the first set of data to identify the characteristics of fallout with respect to the at least one of the service order workflow, the business logic, or the business rules, and/or the like, (at block 410) may comprise: performing, using the computing system, data classification on the first set of data, by providing data labelling to the first set of data based at least in part on type of data (block 410a); performing, using the computing system, data cleaning on the first set of data based at least in part on the data classification to produce a second set of data, the second set of data including, without limitation, at least one of data associated with the service order workflow, data associated with a fallout event, or event data, and/or the like, without private data associated with a customer and without customer proprietary data, or the like (block 410b); performing, using the computing system, data aggregation on the second set of data to produce aggregated data for each of the at least one of the data associated with the service order workflow, the data associated with the fallout event, or the event data, and/or the like, based at least in part on data labelling and data classification (block 410c); performing, using the computing system, feature extraction on the aggregated data to identify at least one of key features or attributes of data associated with the service order workflow from among the aggregated data (block 410d); analyzing, using a business logic manager of the computing system, the identified at least one of key features or attributes of the data associated with the service order workflow from among the aggregated data to identify at least one of one or more business logic or one or more business rules that either are impacted by the identified fallout event or are contributing to occurrence of the identified fallout event (block 410e); and identifying, using the learning model, the characteristics of fallout with respect to the at least one of the service order workflow, the business logic, or the business rules, and/or the like, based at least in part on the identified at least one of key features or attributes of the data associated with the service order workflow from among the aggregated data and the identified at least one of one or more business logic or one or more business rules that either are impacted by the identified fallout event or are contributing to occurrence of the identified fallout event (block 410f).

In some instances, the learning model may be an artificial intelligence (“AI”) model. In such cases, method 400 may further comprise, at block 410g, updating, using the computing system, the learning model to improve identification of the characteristics of fallout with respect to the at least one of the service order workflow, the business logic, or the business rules, and/or the like, based at least in part on any changes to the characteristics of fallout with respect to the at least one of the service order workflow, the business logic, or the business rules, and/or the like, due to one or more of the identified at least one of key features or attributes of the data associated with the service order workflow from among the aggregated data or the identified at least one of one or more business logic or one or more business rules that either are impacted by the identified fallout event or are contributing to occurrence of the identified fallout event, and/or the like.

Referring to the non-limiting embodiment of FIG. 4D, method 400 may comprise, at block 405′, receiving, using a computing system, dynamic point of failure (“POF”) data that simulates POF data corresponding to one or more potential fallout events occurring in a service order workflow through an ordering and provisioning system, the service order workflow corresponding to ordering and provisioning of a service or a product that is provided or sold by a service provider.

At block 410′, method 400 may comprise analyzing, using the computing system, the dynamic POF data to identify characteristics of potential fallout with respect to at least one of the service order workflow, business logic, or business rules, and/or the like, that are associated with the ordering and provisioning of the service or the product using the ordering and provisioning system, based on a learning model. In some instances, the potential fallout may include, but is not limited to, at least one of a potential blockage, a potential break, or a potential disruption in the service order workflow with respect to at least one of one or more software components or one or more hardware components of the ordering and provisioning system.

Method 400 may further comprise, at block 415′, analyzing, using a resolution engine of the computing system, the identified characteristics of the potential fallout with respect to the at least one of the service order workflow, the business logic, or the business rules, and/or the like, to perform at least one of identifying one or more patterns or signatures of an identified potential fallout event, identifying one or more root causes of the identified potential fallout event, or generating a dynamic prioritization map for resolving the identified potential fallout event, and/or the like.

Method 400 may further comprise generating, using the computing system, one or more recommendations regarding the identified potential fallout event based on at least one of the identified patterns or signatures of the identified potential fallout event, the identified one or more root causes of the identified potential fallout event, or the generated dynamic prioritization map for resolving the identified potential fallout event, and/or the like (block 420′); and sending, using the computing system, the one or more recommendations, e.g., to a user (e.g., to user device(s) 160 associated with corresponding user(s) 165 in FIG. 1, or the like) (block 425′).

At block 430′, method 400 may comprise generating, using the computing system, additional dynamic POF data that simulates POF data corresponding to one or more additional potential fallout events occurring in the service order workflow across at least one of an application layer of the ordering and provisioning system or a network layer of the ordering and provisioning system. Method 400 may further comprise, at block 435, feeding, using the computing system, the generated additional dynamic POF data through a feedback loop. Method 400 may return to the process at block 405′, and may repeat, a plurality of times with different dynamic POF data for each repetition, the processes of receiving the dynamic POF data (at block 405′), analyzing the dynamic POF data (at block 410′), analyzing the identified characteristics of the potential fallout (at block 415′), generating (at block 420′) and sending (at block 425′) the one or more recommendations, generating the additional dynamic POF data (at block 430′), and feeding the additional dynamic POF data through the feedback loop (at block 435′), to anticipate, and to recommend fixes for, additional potential fallout events before they occur. Alternatively, or additionally, similar to the processes in FIG. 4A, method 400, as shown in FIG. 4D, may continue onto the process at block 440 in FIG. 4B following the circular marker denoted, “A.”

The processes of blocks 405′-435′ may otherwise be similar, if not identical, to the corresponding processes in FIG. 4A.

Examples of System and Hardware Implementation

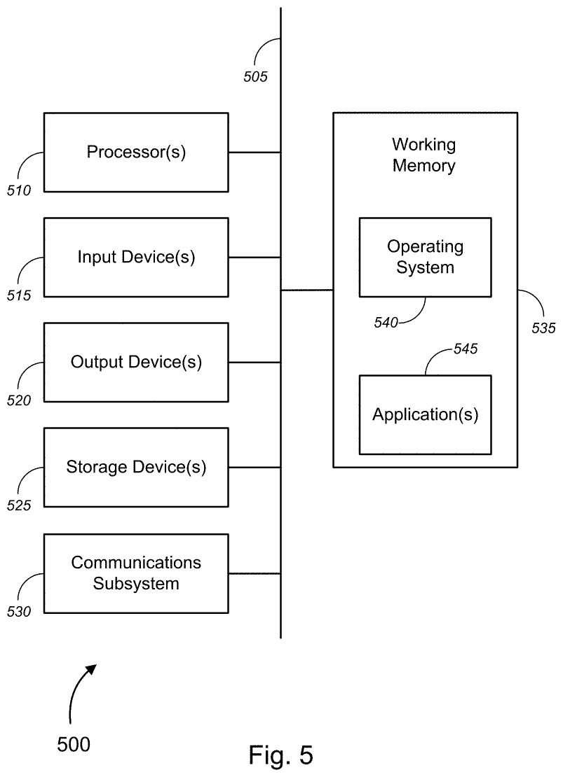

FIG. 5 is a block diagram illustrating an example of computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing system 105, artificial intelligence (“AI”) system 115, resolution engine 120, application layer components 150 and 150a-150c, network layer components 155 and 155a-155c, and user devices 160a-160n, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing system 105, AI system 115, resolution engine 120, application layer components 150 and 150a-150c, network layer components 155 and 155a-155c, and user devices 160a-160n, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi® device, a WiMax® device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with particular requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in some fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While particular features and aspects have been described with respect to some embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while particular functionality is ascribed to particular system components, unless the context dictates otherwise, this functionality need not be limited to such and can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—particular features for ease of description and to illustrate some aspects of those embodiments, the various components and/or features described herein with respect to a particular embodiment can be substituted, added and/or subtracted from among other described embodiments, unless the context dictates otherwise. Consequently, although several embodiments are described above, it will be appreciated that the invention is intended to cover all modifications and equivalents within the scope of the following claims.

What is claimed is:

1. A method, comprising:
receiving, using a computing system, a first set of data associated with a service order workflow through an ordering and provisioning system, the service order workflow corresponding to ordering and provisioning of a service or a product that is provided or sold by a service provider;
analyzing, using the computing system, the first set of data to identify characteristics of fallout with respect to at least one of the service order workflow, business logic, or business rules that are associated with the ordering and provisioning of the service or the product using the ordering and provisioning system, based on a learning model, wherein fallout comprises at least one of a blockage, a break, or a disruption in the service order workflow with respect to at least one of one or more software components or one or more hardware components of the ordering and provisioning system;
analyzing, using a resolution engine of the computing system, the identified characteristics of fallout with respect to the at least one of the service order workflow, the business logic, or the business rules to perform at least one of identifying one or more patterns or signatures of an identified fallout event, identifying one or more root causes of the identified fallout event, or generating a dynamic prioritization map for resolving the identified fallout event; and
generating and sending, using the computing system, one or more recommendations regarding the identified fallout event based on at least one of the identified patterns or signatures of the identified fallout event, the identified one or more root causes of the identified fallout event, or the generated dynamic prioritization map for resolving the identified fallout event.

2. The method of claim 1, wherein the computing system comprises at least one of a fallout management engine (“FAME”), an artificial intelligence (“AI”) system, a machine learning system, a deep learning system, a server computer over a network, a cloud computing system, or a distributed computing system.

3. The method of claim 1, wherein the first set of data comprises at least one of event data, real-time event data, logged event data, simulated event data, point of failure (“POF”) data, static POF data, dynamic POF data, actual POF data, simulated POF data, information technology service management (“ITSM”) data, workflow event data, ordering and provisioning system workflow event data, business workflow event data, service workflow event data, order workflow event data, service order management input data, product order management input data, service order incident data, product order incident data, warning data, event log data, error data, alert data, human resources input data, service team input data, or sales team input data.

4. The method of claim 1, wherein analyzing the first set of data to identify the characteristics of fallout with respect to the at least one of the service order workflow, the business logic, or the business rules comprises:
performing, using the computing system, data classification on the first set of data, by providing data labelling to the first set of data based at least in part on type of data;
performing, using the computing system, data cleaning on the first set of data based at least in part on the data classification to produce a second set of data, the second set of data comprising at least one of data associated with the service order workflow, data associated with a fallout event, or event data, without private data associated with a customer and without customer proprietary data;
performing, using the computing system, data aggregation on the second set of data to produce aggregated data for each of the at least one of the data associated with the service order workflow, the data associated with the fallout event, or the event data, based at least in part on data labelling and data classification;
performing, using the computing system, feature extraction on the aggregated data to identify at least one of key features or attributes of data associated with the service order workflow from among the aggregated data;
analyzing, using a business logic manager of the computing system, the identified at least one of key features or attributes of the data associated with the service order workflow from among the aggregated data to identify at least one of one or more business logic or one or more business rules that either are impacted by the identified fallout event or are contributing to occurrence of the identified fallout event; and
identifying, using the learning model, the characteristics of fallout with respect to the at least one of the service order workflow, the business logic, or the business rules, based at least in part on the identified at least one of key features or attributes of the data associated with the service order workflow from among the aggregated data and the identified at least one of one or more business logic or one or more business rules that either are impacted by the identified fallout event or are contributing to occurrence of the identified fallout event.

5. The method of claim 4, wherein the learning model is an artificial intelligence (“AI”) model, wherein the method further comprises:
updating, using the computing system, the learning model to improve identification of the characteristics of fallout with respect to the at least one of the service order workflow, the business logic, or the business rules, based at least in part on any changes to the characteristics of fallout with respect to the at least one of the service order workflow, the business logic, or the business rules due to one or more of the identified at least one of key features or attributes of the data associated with the service order workflow from among the aggregated data or the identified at least one of one or more business logic or one or more business rules that either are impacted by the identified fallout event or are contributing to occurrence of the identified fallout event.

6. The method of claim 1, wherein the first set of data comprises at least one of end-to-end (“E2E”) data associated with the entire service order workflow across an application layer of the ordering and provisioning system or E2E data associated with the entire service order workflow across a network layer of the ordering and provisioning system, wherein analyzing the first set of data to identify the characteristics of fallout with respect to the at least one of the service order workflow, the business logic, or the business rules comprises analyzing, using the computing system, the first set of data to identify characteristics of fallout across the entire service order workflow across at least one of the application layer or the network layer, with respect to at least one of the service order workflow, business logic, or business rules that are associated with the ordering and provisioning of the service or the product using the ordering and provisioning system, based on the learning model.

7. The method of claim 6, wherein the E2E data associated with the entire service order workflow across the application layer of the ordering and provisioning system comprises E2E data associated with the entire application layer, wherein the E2E data associated with the entire service order workflow across the network layer of the ordering and provisioning system comprises E2E data associated with the entire network layer, wherein the one or more software components are associated with the application layer, and wherein the one or more hardware components are associated with the network layer.

8. The method of claim 1, wherein performing the at least one of identifying the one or more patterns or signatures of the identified fallout event, identifying the one or more root causes of the identified fallout event, or generating the dynamic prioritization map for resolving the identified fallout event occurs in real-time or near-real-time, wherein the identified patterns or signatures are real-time or near-real-time patterns or signatures of the identified fallout event, the identified one or more root causes are real-time or near-real-time root causes of the identified fallout event, or the generated dynamic prioritization map is a real-time or near-real-time dynamic prioritization map for resolving the identified fallout event.

9. The method of claim 1, further comprising:
generating, using the computing system, dynamic point of failure (“POF”) data that simulates POF data corresponding to one or more potential fallout events occurring in the service order workflow across at least one of an application layer of the ordering and provisioning system or a network layer of the ordering and provisioning system;
and feeding, using the computing system, the generated dynamic POF data through a feedback loop, and repeating the processes of receiving the first set of data, analyzing the first set of data, analyzing the identified characteristics of fallout, and generating and sending the one or more recommendations, to anticipate, and to recommend fixes for, potential fallout events before they occur, wherein the first set of data comprises the generated dynamic POF data.

10. The method of claim 9, wherein the processes of generating the dynamic POF data, feeding the generated dynamic POF data through the feedback loop, receiving the first set of data, analyzing the first set of data, analyzing the identified characteristics of fallout, and generating and sending the one or more recommendations are repeated one or more times with different dynamic POF data being generated and used as the first set of data for each repetition, to anticipate, and to recommend fixes for, additional potential fallout events before they occur.

11. The method of claim 1, further comprising:
determining, using the computing system, a tolerance level for a class of service or product associated with the service or product that is provided or sold by the service provider;
determining, using the computing system, a confidence level corresponding to at least one of a level of confidence that the identified patterns or signatures correspond to actual patterns or signatures of the identified fallout event, a level of confidence that the identified one or more root causes correspond to actual root causes of the identified fallout event, or a level of confidence that the generated dynamic prioritization map corresponds to a viable dynamic prioritization map for resolving the identified fallout event; and
based on a determination that the determined confidence level exceeds the determined tolerance level for the class of service or product associated with the service or product that is provided or sold by the service provider, generating, using the computing system, one or more automated repair protocols, and implementing, using the computing system, the one or more automated repair protocols, wherein the one or more automated repair protocols comprise at least one of one or more new business logic, one or more new business rules, a new service order workflow, one or more automated fixes to one or more existing business logic, one or more automated fixes to one or more existing business rules, or one or more automated fixes to the service order workflow.

12. A system, comprising:
a computing system, comprising:
a resolution engine;
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
receive a first set of data associated with a service order workflow through an ordering and provisioning system, the service order workflow corresponding to ordering and provisioning of a service or a product that is provided or sold by a service provider;
analyze the first set of data to identify characteristics of fallout with respect to at least one of the service order workflow, business logic, or business rules that are associated with the ordering and provisioning of the service or the product using the ordering and provisioning system, based on a learning model, wherein fallout comprises at least one of a blockage, a break, or a disruption in the service order workflow with respect to at least one of one or more software components or one or more hardware components of the ordering and provisioning system;
analyze, using the resolution engine, the identified characteristics of fallout with respect to the at least one of the service order workflow, the business logic, or the business rules to perform at least one of identifying one or more patterns or signatures of an identified fallout event, identifying one or more root causes of the identified fallout event, or generating a dynamic prioritization map for resolving the identified fallout event; and
generate and send one or more recommendations regarding the identified fallout event based on at least one of the identified patterns or signatures of the identified fallout event, the identified one or more root causes of the identified fallout event, or the generated dynamic prioritization map for resolving the identified fallout event.

13. The system of claim 12, wherein the computing system comprises at least one of a fallout management engine (“FAME”), an artificial intelligence (“AI”) system, a machine learning system, a deep learning system, a server computer over a network, a cloud computing system, or a distributed computing system.

14. The system of claim 12, wherein the first set of data comprises at least one of event data, real-time event data, logged event data, simulated event data, point of failure (“POF”) data, static POF data, dynamic POF data, actual POF data, simulated POF data, information technology service management (“ITSM”) data, workflow event data, ordering and provisioning system workflow event data, business workflow event data, service workflow event data, order workflow event data, service order management input data, product order management input data, service order incident data, product order incident data, warning data, event log data, error data, alert data, human resources input data, service team input data, or sales team input data.

15. The system of claim 12, wherein the first set of data comprises at least one of end-to-end (“E2E”) data associated with the entire service order workflow across an application layer of the ordering and provisioning system or E2E data associated with the entire service order workflow across a network layer of the ordering and provisioning system, wherein analyzing the first set of data to identify the characteristics of fallout with respect to the at least one of the service order workflow, the business logic, or the business rules comprises analyzing, using the computing system, the first set of data to identify characteristics of fallout across the entire service order workflow across at least one of the application layer or the network layer, with respect to at least one of the service order workflow, business logic, or business rules that are associated with the ordering and provisioning of the service or the product using the ordering and provisioning system, based on the learning model.

16. The system of claim 12, wherein performing the at least one of identifying the one or more patterns or signatures of the identified fallout event, identifying the one or more root causes of the identified fallout event, or generating the dynamic prioritization map for resolving the identified fallout event occurs in real-time or near-real-time, wherein the identified patterns or signatures are real-time or near-real-time patterns or signatures of the identified fallout event, the identified one or more root causes are real-time or near-real-time root causes of the identified fallout event, or the generated dynamic prioritization map is a real-time or near-real-time dynamic prioritization map for resolving the identified fallout event.

17. The system of claim 12, wherein the first set of instructions, when executed by the at least one first processor, further causes the computing system to:
generate dynamic point of failure (“POF”) data that simulates POF data corresponding to one or more potential fallout events occurring in the service order workflow across at least one of an application layer of the ordering and provisioning system or a network layer of the ordering and provisioning system; and
feed the generated dynamic POF data through a feedback loop, and repeat the processes of receiving the first set of data, analyzing the first set of data, analyzing the identified characteristics of fallout, and generating and sending the one or more recommendations, to anticipate, and to recommend fixes for, potential fallout events before they occur, wherein the first set of data comprises the generated dynamic POF data.

18. The system of claim 17, wherein the processes of generating the dynamic POF data, feeding the generated dynamic POF data through the feedback loop, receiving the first set of data, analyzing the first set of data, analyzing the identified characteristics of fallout, and generating and sending the one or more recommendations are repeated one or more times with different dynamic POF data being generated and used as the first set of data for each repetition, to anticipate, and to recommend fixes for, additional potential fallout events before they occur.

19. The system of claim 12, wherein the first set of instructions, when executed by the at least one first processor, further causes the computing system to:
determine a tolerance level for a class of service or product associated with the service or product that is provided or sold by the service provider;
determine a confidence level corresponding to at least one of a level of confidence that the identified patterns or signatures correspond to actual patterns or signatures of the identified fallout event, a level of confidence that the identified one or more root causes correspond to actual root causes of the identified fallout event, or a level of confidence that the generated dynamic prioritization map corresponds to a viable dynamic prioritization map for resolving the identified fallout event;
based on a determination that the determined confidence level exceeds the determined tolerance level for the class of service or product associated with the service or product that is provided or sold by the service provider, generate one or more automated repair protocols, and implement the one or more automated repair protocols, wherein the one or more automated repair protocols comprise at least one of one or more new business logic, one or more new business rules, a new service order workflow, one or more automated fixes to one or more existing business logic, one or more automated fixes to one or more existing business rules, or one or more automated fixes to the service order workflow.

20. A method, comprising:
receiving, using a computing system, dynamic point of failure (“POF”) data that simulates POF data corresponding to one or more potential fallout events occurring in a service order workflow through an ordering and provisioning system, the service order workflow corresponding to ordering and provisioning of a service or a product that is provided or sold by a service provider;
analyzing, using the computing system, the dynamic POF data to identify characteristics of potential fallout with respect to at least one of the service order workflow, business logic, or business rules that are associated with the ordering and provisioning of the service or the product using the ordering and provisioning system, based on a learning model, wherein the potential fallout comprises at least one of a potential blockage, a potential break, or a potential disruption in the service order workflow with respect to at least one of one or more software components or one or more hardware components of the ordering and provisioning system;
analyzing, using a resolution engine of the computing system, the identified characteristics of the potential fallout with respect to the at least one of the service order workflow, the business logic, or the business rules to perform at least one of identifying one or more patterns or signatures of an identified potential fallout event, identifying one or more root causes of the identified potential fallout event, or generating a dynamic prioritization map for resolving the identified potential fallout event;
generating and sending, using the computing system, one or more recommendations regarding the identified potential fallout event based on at least one of the identified patterns or signatures of the identified potential fallout event, the identified one or more root causes of the identified potential fallout event, or the generated dynamic prioritization map for resolving the identified potential fallout event;
generating, using the computing system, additional dynamic POF data that simulates POF data corresponding to one or more additional potential fallout events occurring in the service order workflow across at least one of an application layer of the ordering and provisioning system or a network layer of the ordering and provisioning system;
feeding, using the computing system, the generated additional dynamic POF data through a feedback loop; and
repeating, a plurality of times with different dynamic POF data for each repetition, the processes of receiving the dynamic POF data, analyzing the dynamic POF data, analyzing the identified characteristics of the potential fallout, generating and sending the one or more recommendations, generating the additional dynamic POF data, and feeding the additional dynamic POF data through the feedback loop, to anticipate, and to recommend fixes for, additional potential fallout events before they occur.
